(19) United States
(12) Patent Application Publication
(10) Pub. No.: US 2026/0358053 A1
(43) Pub. Date: Nov. 12, 2026

(54) METHOD FOR CALCINING CARBONATED MINERAL STONES IN A PARALLEL FLOW REGENERATIVE KILN AND IMPLEMENTED KILN

(71) Applicant: S.A. Lhoist Recherche et Developpment, Ottignies-Louvain-la Neuve (BE)

(72) Inventors: Olivier Van Cantfort, Woluwe-Saint Pierre (BE); Tristan Cloarec, Urdo (FR)

(73) Assignee: S.A. Lhoist Recherche et Developpement, Ottignies-Louvain-la Neuve (BE)

(21) Appl. No.: 19/139,789

(22) PCT Filed: Dec. 28, 2023
(86) PCT No.: PCT/EP2023/087892

§ 371 Date: Jun. 16, 2025

(30) Foreign Application Priority Data
Dec. 30, 2022 (EP) 22217327.0

(51) Int. Cl. F27B 1/00; F27B 1/04; F27B 1/08; F27B 1/16; F27B 1/24; F27D 17/18

(52) U.S. Cl. CPC F27B 1/005; F27B 1/04; F27B 1/08; F27B 1/16; F27B 1/24; F27D 17/18

(57) ABSTRACT

Parallel flow regenerative kiln, comprising at least two shafts (1, 2) interconnected by a crossover channel (4), wherein each shaft comprises means for injecting a heated gas (6, 7) inside the shaft (1) in calcination working at the top of the calcination zone (B) and both from the middle of this shaft and from its periphery, the kiln further comprising an external recirculation circuit (18) which comprises a separation body (17) for taking off a fraction of the gaseous effluent from said removal duct (14), a heating device (20) able to heat gas which is connected with said separation body (17) and arranged for heating said fraction of gaseous effluent, and said means for injecting a heated gas (6, 7) inside the shaft (1) in calcination working, which are connected to the heating device (20) and inject the heated fraction of gaseous effluent at a temperature equal or higher than the temperature of calcination of the loaded mineral stones, and method for calcining carbonated mineral stones with such a kiln.

The present invention relates to a method for calcining carbonated mineral stones in a parallel flow regenerative kiln (PFRK). Such a kiln comprises at least two shafts interconnected by means of a crossover channel. In each shaft the stones are introduced in a top portion and follow a downward gravity displacement during which the stones are successively preheated, calcined and thereafter cooled in order to be collected in a low portion of each shaft.

By the terms “stones, carbonated mineral stones, limestone stones”, it is meant according to the present invention pieces of raw carbonated material having a mean particle size d₅₀ comprised between 20 mm to 20 cm, preferably higher than 25 mm, preferably lower than 18 cm, more preferably lower than 16 cm, and typically between 3 and 15 cm Carbonated mineral according to the present patent application is typically a calcium-magnesium carbonate, also known as limestone.

A Parallel Flow Regenerative Kiln has usually 2 to 3 shafts, circular or rectangular, which do not work in a continuous way. In standard operation, in every period, usually of 12 to 20 minutes, a fuel is injected inside a calcining zone of one shaft by means of lances and is burned in presence of combustion air. Thereafter the descending calcined product is cooled in a cooling zone by heat exchange with a cooling air introduced at the bottom of the shaft. The flue gas consists in the combustion gas, the gas of decarbonation and the heated cooling air. This flue gas is drawn into another shaft through the crossover channel and thereafter through the stones present in this shaft and thereafter outward the kiln. So, in this shaft the present stones are preheated by the exiting flue gas. Consequently, during this period, the shaft wherein the combustion takes place works according to a calcining way and the shaft wherein the flue gas is drawn through the stones works according to a preheating way. Thereafter, there is a period, usually between 30 seconds and 2 minutes, called inversion period, which is provided for reverting the air and fuel circuits. And the shaft having worked in a calcining way works now in a preheating way and the shaft having worked in a preheating way works now in a calcining way.

The classical method for calcining carbonated mineral stones in a parallel flow regenerative kiln having at least two shafts interconnected by a crossover channel, comprises, in standard operation,
loading carbonated mineral stones at the top of each shaft,
preheating these loaded stones in a preheating zone,
calcining these preheated stones in a calcination zone with production of a decarbonated calcined material,
cooling the calcined material with cooling air in a cooling zone, with formation of heated cooling air by heat exchange,
discharging the calcined material from the bottom of the shafts,
exhausting a gaseous effluent from the kiln,
each shaft alternately working in a calcining way and in a regenerative way, one shaft working in a calcination way during a predetermined time period during which at least another shaft works in a preheating way, and inversely,
the calcining way comprising:
   said loading step of carbonated mineral stones at the top of a kiln shaft,
   said calcining step by means of an increase of temperature inside said carbonated mineral stones having been preheated, with production of said decarbonated calcined material and release of a gaseous stream which flows in co-current with the calcined material, and
   through said crossover channel, a passage of said gaseous stream toward the at least one shaft working in a preheating way,
said preheating way comprising:
   said preheating step of the loaded carbonated mineral stones by heat exchange with said gaseous stream coming from the crossover channel, which is ascending and flows in counter-current through the loaded carbonated mineral stones, and
   said exhausting step of said gaseous stream as gaseous effluent at the top of said at least one shaft in preheating way,
   said cooling step comprising a supply of cooling air at the bottom of each of said shafts or only of the shaft working in the calcining way.

In the calcining zone of a classical kiln, it is required in calcining way to inject and burn a fuel into the mass of the stones to be calcined under the preheated stones in order to benefit from the heat of the combustion. In preheating way, the stones introduced into the kiln are at ambient temperature and the flue gas drawn outside the kiln is at about 150 °C, limiting the energy losses.

According to the invention, standard operation means that the kiln produces the calcined material in a continuous manner. This operation does not concern the phases of starting, stopping or maintenance of the kiln.

According to the invention, carbonated mineral stones particularly mean calcareous stones (limestones), dolomitic stones (dolostones or unburnt dolomites) and/or magnesite stones which are calcined in quicklime, quick dolime and/or magnesia.

The calcination reaction of limestone into quicklime is:

CaCO₃ (solid)+heat→CaO (solid)+CO₂ (gas)

This reaction is endothermic and reversible. Below 850 to 900 °C lime and CO₂ can easily recombine. But from a temperature of the order of 900 °C the starting stones give off a significative volume of CO₂ during their decarbonation. In order to obtain such a decarbonation, the temperature must consequently be significatively increased in the calcining zone. Today this increase is mainly obtained by combustion of a fuel, frequently fossil, in presence of an oxidizer as air. In turn this fuel combustion contributes also to an important release of CO₂. Globally the current calcination methods actively participate in increasing the greenhouse effect.

During the fuel combustion a direct contact of the flame with the preheated carbonated mineral stones also results in possible local overheat in the calcination zone and the possibility that the flue gas would contaminate the calcined material. A prior careful selection of the fuel is required to maintain a high quality of the calcined material, notably while avoiding high sulfur fuels. Even with selected fossil fuels, the calcined material reactivity will be affected by the fuel ash and the minor pollutants. During the combustion at high temperatures fuel and thermal NOx are also generated due to nitrogen possibly in the fuel but moreover at high contents of nitrogen in the combustion air.

This very common calcination process has also the disadvantage of proposing a combustion of fuel with air and a cooling of the calcined product with air. This results in the release at the top of the kiln of a gaseous effluent having a high level of diatomic nitrogen N₂, and a comparatively low level of CO₂ (concentration by volume of the order of 20% to 27% on dry gas). Due to this high presence of nitrogen in the air, a capture of CO₂ is very difficult and expensive.

Variation of the common calcination process have been proposed in order to improve capture of CO₂, such as for example in WO2022/002869 or WO2022229120.

The object of the present invention is to remedy the problem of significant CO₂ emissions of PFRK kilns, without substantially modifying their cyclic functioning and by making little or no changes to their structure. Another object is to avoid as much as possible overheat of the calcined material and introduction of impurities in this material. An object of the invention consists also to make easier a capture of CO₂ in the gaseous effluent exiting from the kiln. The main object of the calcination kilns must obviously be maintained, i.e. the production of a very uniform calcined material of high quality and purity.

In order to solve these problems, according to the invention a method as above indicated further comprises
recirculating a fraction of the gaseous effluent exhausted from the top of said at least one shaft in preheating way,
outside the kiln, heating said recirculated fraction of gaseous effluent by means of at least one heating device able to heat gas, and
injecting the heated recirculated fraction of gaseous effluent into the shaft working in calcining way at a level which is located at the top of the calcination zone and both from the middle of this shaft and from its periphery, in order to obtain said increase of temperature allowing a calcining of the carbonated mineral stones in an evenly distributed manner.

The invention relies mostly on externalizing the energy supply while heating a recirculated gas with a heating device able to heat gas. A gas having a determined temperature entering in such a device exits therefrom at a higher temperature. Such a device may be for example a furnace equipped with at least one torch of plasma, an induction heating device, radiant panels, a microwave oven, a solar heating device, an oxyfuel burner, an heater by indirect exchange, their combination and so on. And the devices able to release a heat gas resulting from a reaction, as for example from a combustion, are not included in the meaning of heating device able to heat a gas of the invention.

In a variant embodiment, such a device can be a combination of the furnace equipped with at least one torch of plasma, an induction heating device, radiant panels, a microwave oven, a solar heating device with a combustion furnace (indirect combustion heating, oxycombustion, and so on); a switch is to be provided in between. In this way, depending on the availability and price of the energy, a switch can be operated between the furnace of the combination.

The injection system of the kiln of the invention is optimized to get a good heat distribution with no preferential flow of the heated gas in the periphery of the shaft. So, the quality of the calcined material is widely improved.

No fuel and no air are still necessary for a combustion inside the kiln. Consequently, no or little additional pollutant will be emitted apart from the minor ones contained in the stones. No ash will be produced resulting to a pure decarbonated material. As nitrogen content of the gas is limited, no or little NOx will be produced enabling the plants to comply with stricter regulations. Overheating of the stones by direct contact with a flame is not to fear. The appropriate temperature of the heated gas from the heating device is controlled very easily, leading to a high quality of lime. According to the invention the heated recirculated gas is introduced inside the shaft in calcination way at the top of the calcining zone, just below the preheating zone, keeping so all the regenerative features of the kiln.

According to a preferable embodiment of the invention, the method further comprises a step for extracting the heated cooling air from each shaft wherein cooling air has been supplied, at a level located below the crossover channel, the gaseous effluent exiting from the kiln being CO₂ concentrated. As an extraction of the heated cooling air from the shafts takes place at a level located below the crossover channel, the gaseous effluent removed from the kiln is formed almost substantially of the gaseous stream resulting from the decarbonation and of the CO₂ based gas injected in the shaft in calcination way and optionally in the crossover channel. Therefrom it results that the gaseous effluent exhausted from the furnace has a concentrated CO₂ content, typically of at least 80% by volume on dry gas, preferably of at least 90% by volume, most preferably at least 95%.

By the term “CO₂ concentrated” or “CO₂ concentrated gaseous effluent”, or “gaseous effluent concentrated in CO₂”, it is meant according to the present invention that the content of CO₂ is of at least 65%, particularly of at least 70%, more preferably of at least 80% by volume on dry gas, preferably of at least 90% by volume on dry gas, most preferably at least 95% vol on dry gas.

Such a gaseous effluent may be useable or sequestered in favorable conditions and so reduces the contribution to the greenhouse effect of the kiln.

According to an embodiment of the invention, at least one heat exchange between the heated cooling air, which has been extracted outside the kiln, and said recirculated fraction of the gaseous effluent takes place before said step of heating by means of said device able to heat a gas. Such a heat exchange allows to recover heat from the extracted cooling air before the heating step and the air released in the atmosphere is closer to the ambient temperature.

According to an advantageous embodiment of the invention, the method comprises an introduction into the crossover channel of a gaseous mixture of a first part of said recirculated fraction of gaseous effluent which has been heated outside the kiln by means of said device able to heat a gas and of a second part of said fraction which has not been heated by said device, said mixture so having an adjusted temperature typically in the range of 900 °C to 1100 °C, higher than the temperature of recarbonation of the calcined mineral stones but lower than said temperature allowing a calcining of the carbonated mineral stones, which is preferably in the range of 1100 to 1500 °C.

Alternatively, the gaseous stream introduced into the crossover channel is the said second part of said fraction which has not been heated by said device heated by a separate heating device to the adjusted temperature lower than said temperature allowing a calcining of the carbonated mineral stones but higher than the temperature of recarbonation of the calcined mineral stones.

By the terms “adjusted temperature lower than said temperature allowing a calcining of the carbonated mineral stones but higher than the temperature of recarbonation of the calcined mineral stones”, it is meant according to the present invention a temperature in the range of 900 °C to 1100 °C, preferably from 950 °C to 1100 °C.

By the terms “temperature allowing a calcining of the carbonated mineral stones”, it is meant according to the present invention a temperature in the range of 950 °C to 1500 °C, preferably in the range of 1100 °C to 1400 °C.

According to a preferable embodiment of the invention, a portion of the recirculated fraction of gaseous effluent which has not been heated is injected at the top of each shaft in calcining way.

In a particular case, the method takes place in a 2-shafts kiln.

The present invention also concerns a parallel flow regenerative kiln. Such a kiln comprises at least two shafts interconnected by a crossover channel,
each shaft comprising, in position in service or out of service,
   at least one entrance opening for loading carbonated mineral stones, at the top of the shaft,
   at least one exit opening for discharging a decarbonated calcined material, at the bottom of the shaft,
   a removal duct for exhausting a gaseous effluent from the top of the shaft, and
   a cooling air supply at the bottom of the shaft for cooling the decarbonated calcined material to be discharged,
the kiln further comprising a reversing system which is arranged to drive said positions in service and out of service of each shaft alternately in calcination working and in preheating working, a shaft being in calcination working during a predetermined time period while at least another shaft is in preheating working and inversely according to the control of said reversing system,
the shaft in calcining working comprising from the top to the bottom successively a preheating zone, a calcination zone and a cooling zone, and said interconnecting crossover channel being located at the bottom of the calcination zone.

According to the invention, each shaft comprises means for injecting a heated gas inside the shaft in calcination working at the top of the calcination zone and both from the middle of this shaft and from its periphery,
and the kiln further comprises an external recirculation circuit which comprises
   a separation body for taking off a fraction of said gaseous effluent from said removal duct,
   a heating device able to heat gas which is connected with said separation body and arranged for heating said fraction of gaseous effluent, and
   said means for injecting a heated gas inside the shaft in calcination working, which are connected to the heating device and inject said heated fraction of gaseous effluent at a temperature equal or higher than the temperature of calcination of the loaded mineral stones.

According to the invention, the heating device may be a furnace equipped with at least one torch of plasma, an induction heating device, radiant panels, a microwave oven, a solar heating device, an oxyfuel burner or an heater by indirect exchange. The heating device is accordingly located externally with respect to the furnace since it is a part of the external recirculation circuit, by opposition to burners located inside shafts, (see for example burners according to DE3145549). This arrangement aims to make little or no changes to the structure of the kiln and to provide flexibility for using the heated gas where needed. The heating device is connected to the means for injecting the heated gas inside the shaft with communication nozzle across the wall of each shaft.

As explained above, the PFRK kiln has a cyclic operation, each shaft operating for a predetermined period of time in calcining way, then, after an inversion time, usually between 30 seconds and 2 minutes, in preheating way, and so on. During the inversion time the inversion system synchronously controls all the changes necessary to pass from one way to another, for example by opening means for injecting a gas inside the shaft working in calcination way and closing them when the shaft is switched to the preheating way. The inversion system therefore not only controls numerous flaps and valves, but also the operation of loading and unloading equipment or even that of various suction, pumping or injection elements.

Preferably, the kiln comprises means for removing from the kiln the cooling air which has been heated in contact with the calcined material, at a level lower than the crossover channel.

Advantageously, at the bottom of each shaft, at a level lower than the crossover channel, said means for removing heated cooling air from the kiln may comprise a central collector element, which communicates with an external extracting device.

According to an embodiment of the invention, said means for injecting a heated gas comprise a tube, preferably a cylindrical tube or a tube with a rectangular section which is suspended in the middle of each shaft and which is provided with perforations at the top of the calcining zone as well as, in each shaft, with additional holes in their shell at the same level. This configuration with a cylindrical tube as one of the means for injecting a heated gas is even more advantageous when the shafts of the kiln have a circular section.

The configuration with a tube having a rectangular section can be more preferable when the shaft has a rectangular section.

By the terms “cylindrical tube suspended in the middle of each shaft, it is meant according to the present invention that the cylindrical tube is installed around a central point of the cross-section of the shaft.

According to some embodiments of the kiln, each shaft has a circular section and is provided with a peripheral channel at the bottom of the calcination zone, said crossover channel interconnecting the peripheral channels of the shafts in order to allow a passage of gas from one shaft to another one. At a level lower than the peripheral channels and the crossover channel, said means for removing heated cooling air from the kiln may comprise an annular collector which communicates with an external extracting device.

According to other kilns, each shaft has a rectangular section, a side of one shaft facing a side of another shaft, the crossover channel interconnecting directly the shafts between said facing sides. At a level below the crossover channel, said means for removing heated cooling air from the kiln comprise on at least some sides of each shaft at least one collector which communicates with an external extracting device.

Advantageously, said means for injecting a heated gas may comprise an inner cylinder which extends axially from the top to the bottom of each shaft and which is divided in two separated parts, an upper part which is connected with the heating device and is provided with perforations at the top of the calcining zone and a lower part which is connected with an external extracting device and is provided with holes at the top of the cooling zone.

According to an embodiment of the invention, the kiln comprises a mixing chamber which is connected to the recirculation circuit downward the heating device in order to collect a first part of said recirculated fraction of gaseous effluent which has been heated and to a separating body which is arranged on the recirculation circuit upwards the heating device and is able to transfer to the mixing chamber a second part of said recirculated fraction of gaseous effluent which has not been heated by said heating device in order to obtain a gaseous mixture having an adjusted temperature lower than a temperature allowing a calcining of the carbonated mineral stones,
said mixing chamber being connected to the crossover channel through a gaseous mixture conduit in order to inject therein said gaseous mixture or to means for injecting a heated gas, through a gaseous mixture conduit in order to inject at the top of the calcination zone said gaseous mixture when the shaft is in preheating way.

When the gaseous mixture is injected in the crossover channel, the adjusted temperature is lower than 1100 °C, preferably between 900 °C and 1100 °C, more preferably between 950 °C and 1100 °C. When the gaseous mixture is injected at the top of the calcination zone when the shaft is in preheating way., the adjusted temperature is lower than 1100 °C, preferably between 500 °C and 1100 °C, more preferably between 550 °C and 950 °C.

Alternatively, the gaseous stream (mixture) introduced into the crossover channel through a gaseous mixture conduit is heated by a separate heating device to the adjusted temperature lower than said temperature allowing a calcining of the carbonated mineral stones but higher than the temperature of recarbonation of the calcined mineral stones.

In yet another alternative embodiment, the gaseous mixture introduced through a gaseous mixture conduit at the top of the calcination zone when the shaft is in preheating way is heated by a separate heating device to the adjusted temperature lower than said temperature allowing a calcining of the carbonated mineral stones but higher than the temperature of recarbonation of the calcined mineral stones.

When the gaseous mixture is injected in the crossover channel, the adjusted temperature is lower than 1100 °C, preferably between 900 °C and 1100 °C, more preferably between 950 °C and 1100 °C. When the gaseous mixture is injected at the top of the calcination zone when the shaft is in preheating way, the adjusted temperature is lower than 1100 °C, preferably between 500 °C and 1100 °C, more preferably between 550 °C and 950 °C.

In some embodiment of the present invention, the means for injecting a heated gas is connected to the source of heated CO₂ based gas, which is outside of the shaft and to the gaseous mixture conduit and the means for injecting a heated gas has a out of service position and a service position for the heated CO₂ based gas and a out of service position and a service position for the gaseous mixture conduit. This means in other words that the means for injecting a heated gas is typically in service position for the heated CO₂ based gas during calcining way (allowing entry of the heated CO₂ based gas) and out of service position for the gaseous mixture conduit (closing entry of gaseous mixture) and that the means for injecting a heated gas is typically out of service position for the heated CO₂ based gas during preheating way (closing entry of the heated CO₂ based gas) and in service position for the gaseous mixture conduit (allowing entry of the gaseous mixture).

Advantageously, each shaft comprises a top opening for introducing a third part of said taken off fraction of based gaseous effluent, which has not been heated.

Preferably, at least one heat exchanger supplied with heated cooling air extracted from the kiln is arranged on said external recirculation circuit.

As can be seen, the kiln according to the invention has only a few structural modifications made to the exterior of the oven. Existing kilns can therefore easily be fitted out to implement a calcination process according to the invention.

In a particular case, the kiln is a 2-shafts kiln.

Other features and details of the method and kiln according to the invention are indicated in the appended claims.

Other particularities of the invention will also result from the non-limiting description given below, with reference to the Figures.

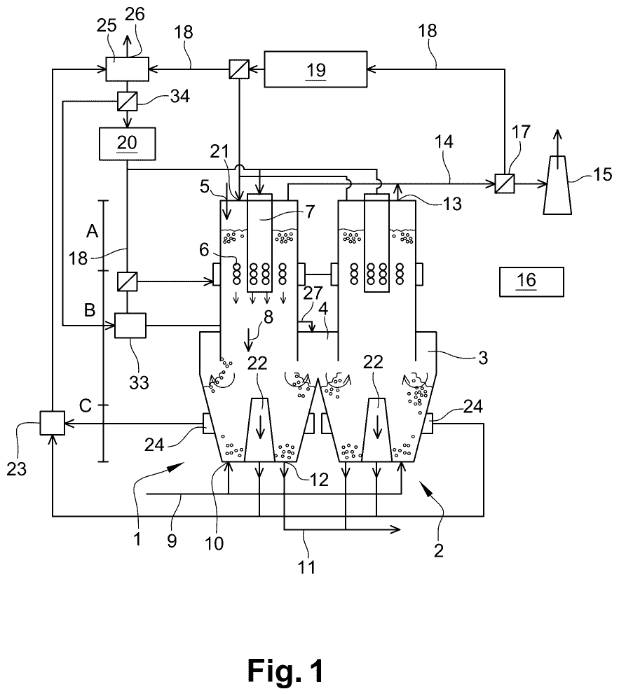

FIG. 1 illustrates schematically an embodiment of PFRK kiln according to the invention.

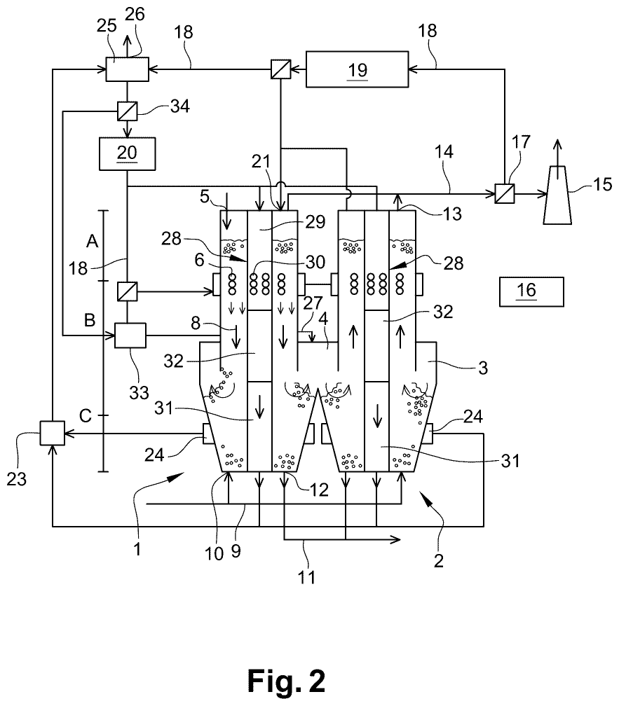

FIG. 2 illustrates schematically another embodiment of PFRK kiln according to the invention.

In the figures, identical or similar elements have the same references. Conventionally the shaft 1 shown on the left works in calcining way and the shaft 2 shown on the right in preheating way.

As can be seen on FIG. 1, the illustrated PFRK kiln comprises two shafts 1, 2 which have a circular section and are provided with peripheral channels 3 which are interconnected by a crossover channel 4. The shafts are divided in height into three zones, the preheating zone A where the carbonated stones are preheated before calcination, the calcination zone B wherein the decarbonation of the carbonated preheated stones takes place and the cooling zone C wherein the cooling of the decarbonated calcined material takes place.

The carbonated stones are introduced at the top of the shafts by means of an entrance opening 5 which is in open position. By gravity the stones gradually descend in the shaft. When the shaft works in calcining way, at the top of the calcining zone B. thus just under the preheating zone A, means for injecting a gas having a temperature equal or higher than the calcination temperature of the stones are provided in service, i.e. a gas temperature of 900 to 1600 °C, preferably of 1100 to 1500 °C. On the illustrated kiln, these means consist in a cylindrical tube 7 which is suspended in the middle of each shaft and which is provided with perforations at the top of the calcining zone and in holes 6 in the external shell of the shaft at the same level, several horizontal layers of injection points being advantageously required to get the right heat distribution. So a uniformly distributed decarbonation of the stones takes place with obtention of a decarbonated calcined material which continues to descend in the shaft and of a gaseous stream 8 which flows in co-current with the calcined material.

Via a supply pipe 9 and a feeding opening 10 which is in open position, cooling air is introduced at the bottom of the shafts. Said cooling air flows in counter-current to the calcined material, for cooling it. The cooled calcined material is discharged into an unloading equipment 11 through the exit opening 12 which is in open position.

Said gaseous stream 8 consists in the CO₂ released during the decarbonation and the heated gas injected inside the shaft. Via the peripheral channel 3, this gaseous stream passes through the crossover channel 4 and thereafter inside the shaft 2 working in preheating way.

When a shaft is working in preheating way, here the shaft 2, the means for injecting a gas 6 and 7 are out of service. On the other hand, the feeding opening 10 for the cooling air and the exit opening 12 for the calcined material remain in the open position. In this shaft 2 the gas stream which comes from the crossover channel 4 progresses to the top of the shaft in counter-current of the stones which are so preheated. Via an outlet opening 13 which is here in open position, gaseous effluents are exhausted from the kiln through a removal duct 14 and a stack 15. In the shaft 1 working in calcination way, the outlet opening 13 of this removal duct 14 is closed.

The kiln also includes a reversing system 16 shown schematically. This system synchronously controls the operation of the shafts, during the inversion time, directly or remotely. The system is arranged to drive said positions in service and out of service of each shaft alternately in calcination working and in preheating working.

Outside of the kiln, on the removal duct 14, a separation body 17 has been provided, which is able of taking off a fraction of the gaseous effluent exhausted from the kiln and of introducing it into a recirculation circuit 18. In this circuit the fraction of gaseous effluent is advantageously treated in a treatment unit 19, wherein it can for example be cooled, filtered and/or dried. The recirculation circuit 18 comprises also an external heating device 20 which is able to heat a gas. This heating device may be driven by the reversing system 16 for supplying a gas having the temperature appropriate for being injected through the perforated cylindrical tube 7 and the holes 6 of the shell of the shaft working in calcination way and for obtaining a thermal decomposition of the preheated stones. A portion of said fraction of gaseous effluent is taken off from the recirculation circuit 18 upstream of the heating furnace 20. This taken off gas has a temperature close to the ambient temperature, preferably below 200 °C) and is introduced in the shaft 1 in calcining way at its top opening 21. This opening is closed in the shaft 2 working in preheating way. A cold gas needs to be injected at the top of the shaft 1 to keep the benefit from the regeneration, with a slightly higher pressure. In the kiln illustrated on FIG. 1, the heated cooling air is drawn through a central collector element 22 which communicates with an external extracting device 23 for removing from the kiln, at a level lower than the crossover channel 4, the cooling air which has been heated in contact with the decarbonated calcined material. For the same purpose each circular shaft is also equipped with an annular collector 24 which communicates also with said extracting device 23.

At least one heat exchanger supplied with heated cooling air extracted from the kiln is advantageously arranged on said external recirculation circuit 18. In the kiln of FIG. 1, the heated cooling air drawn by the extracting device 23 is supplied to a heat exchanger 25 wherein a heat exchange takes place with the cold gas exiting from the treatment unit 19. Air at a temperature close to the ambient temperature is so released in the atmosphere by the outlet 26, possibly after treatment such as dust removal, and there is an energy recovering upstream of the heating device 20.

The kiln on FIG. 1 comprises also means for advantageously injecting a heated gas 27 into the crossover channel 4. This gas is supplied from a mixing chamber 33 which is connected to the recirculation circuit 18 downward the heating device 20 in order to collect a first part of said recirculated fraction of gaseous effluent which has been heated and to a separating body 34 which is arranged on the recirculation circuit 18 upwards the heating device 20 and is able to transfer to the mixing chamber 33 a second part of said recirculated fraction of gaseous effluent which has not been heated by said heating device. So a gaseous mixture having an adjusted temperature in the range of 900 to 1100 °C, higher than the temperature of recarbonation of the calcined mineral stones but lower than a temperature allowing a calcining of the carbonated mineral stones being advantageously of 1100 to 1500 °C, is obtained and may be injected by the connection 27 into the crossover channel 4 for compensating the extraction of the heated cooling air from the kiln.

In another embodiment, the gaseous mixture having an adjusted temperature in the range of 900 to 1100 °C to be injected in the crossover channel 4 is generated by a separate heating device, heating to the range of 900 to 1100 °C the second part of said recirculated fraction of gaseous effluent which has not been heated by said heating device 20, to directly be injected by the connection 27 into the crossover channel. This embodiment is not represented in FIG. 1.

In this illustrated kiln the gaseous stream entering the shaft 2 consists almost only in the CO₂ released during the decarbonation in shaft 1, the heated gas injected inside the shaft 1 at the top of the calcining zone B by the means 6 and 7 and the heated gas injected inside the crossover channel by the means 27. This gaseous stream is no more diluted by air, excepted possibly by a little bit false air/cooling air not being extracted. Effectively there is no more need of air for any combustion and the cooling air is extracted from the kiln. Consequently, the CO₂ content of the gaseous effluent exiting from the kiln is highly concentrated. The kiln illustrated on FIG. 2 differs from the kiln of FIG. 1 by the means for injecting a heated gas and the means for extracting the heated cooling air. Each shaft comprises an inner cylinder 28, centrally installed which extends axially from the top to the bottom and which is divided in three separated parts, an upper part 29 which is connected with the heating device and is provided with perforations 30 at the top of the calcining zone and a lower part 31 which is connected with the external extracting device 23 and is provided with holes at the top of the cooling zone. In the illustrated embodiment a central part 32 separates the upper and the lower parts in order they have no communication between them.

### EXAMPLE

The kiln of this example corresponds to the kiln illustrated on FIG. 1 and is conceived for the production of 150 to 760 tons of lime per day. All the mentioned gaseous flows are expressed in Nm³/t of produced lime, on dry gas.

At the top of the shaft 1 working in calcining way, 270 to 1400 tpd (tons per day) of calcareous stones may be loaded through the entrance opening 5. Simultaneously 300 to 500 Nm³/t of recycled gas are introduced by the top opening 20 at a temperature of 30-50 °C in order to benefit from the regeneration and not to obtain too high temperature at the outlet of the kiln.

The means for injecting gas 6 and 7 introduce a hot gas at the top of the calcination zone B through the perforated cylindrical tube 7 and the holes 6 of the shell of the shaft in order to obtain a temperature of 1050-1250 °C at the beginning of the calcination. This temperature corresponds to the temperature of the mixture of the cold gas recycled at the top of the shaft and of the hot gas injected at the top of the calcination zone. This obtained temperature is then widely higher than 900 °C, and therefrom it results a decarbonation of the stones with a release of 360-390 Nm³/t of CO₂ and in the calcination zone there is formation of a gaseous stream of 950-1400 Nm³/t which flows in co-current with the calcined material.

250 to 300 Nm³/t of cooling air are introduced at the bottom of each shaft by a feeding opening 10. After heat exchange with the calcined material, the heated cooling air is extracted from the kiln by the collector elements 22 and 24. In order to compensate this extraction, 0 to 600 Nm³/t of a CO₂ based gas having a temperature of 910-1000 °C are continuously introduced in the crossover channel 4 by the injection means 27. This introduction allows to avoid cooling down the kiln.

After passage through the crossover channel 4 the gaseous stream is drawn toward the outlet opening 16 of the shaft 2 while preheating the stones stored therein. 2000-2100 Nm³/t of gaseous effluent exit from the kiln at a temperature of 150-200 °C.

A fraction of 1500 to 1800 Nm³/t of the gaseous effluent is taken off from the removal duct 17 by the separation body 20 and follows now the recirculation circuit 21 while 300 to 500 Nm³/t thereof are exhausted by the stack 18. This taken off gaseous fraction has a temperature of 120 to 140 °C before entering the treatment unit 19 and 26 to 50 °C after the treatment.

The separation element 34 separates in two parts the taken off gaseous fraction. The first part is transferred to a heating device 20, such as a plasma torch which heats the gaseous flow at a very high temperature of 3000-5000 °C. This heated part is mixed in a controlled manner with a second cold part of the fraction of gaseous effluent in order to obtain in a mixing chamber (not illustrated) a regulated temperature of 1300 to 1500 °C.

In the example of kiln illustrated on FIG. 1 a part of 900 to 1200 Nm³/t of this hot gaseous mixture is injected in the shaft 1 by means of the injection means 6 and 7 as above disclosed while another part of 0 to 600 Nm³/t is transferred to a second mixing chamber 33. There the gaseous flow is mixed in a controlled manner with a cold third part of the fraction of gaseous effluent in order to obtain an adjusted temperature of 910 to 1000 °C 0 to 600 Nm³/t of this mixture are injected in the crossover channel 4 as above disclosed.

The fraction of 300 to 500 Nm³/t of the gaseous effluent which are exhausted by the stack 15 have a CO₂ content of more than 95 vol %, preferably of 98 vol % on dry gas.

Obviously, the present invention is not limited to the disclosed embodiments and several modifications may be provided without being outside the scope of the appended claims.

It is for example possible to envisage some embodiments of kilns according to the invention without the means for removing the heated cooling air from the kiln. In this case the gaseous effluent is diluted by the cooling air, but still avoids in any case the presence of combustion air as in the current PFRK kilns. Such a gaseous effluent is already industrially exploitable.

1: Method for calcining carbonated mineral stones in a parallel flow regenerative kiln having at least two shafts interconnected by a crossover channel, comprising, in standard operation,
loading carbonated mineral stones at the top of each shaft,
preheating these loaded stones in a preheating zone,
calcining these preheated stones in a calcination zone with production of a decarbonated calcined material,
cooling the calcined material with cooling air in a cooling zone, with formation of heated cooling air by heat exchange,
discharging the calcined material from the bottom of the shafts,
exhausting a gaseous effluent from the kiln,
each shaft alternately working in a calcining way and in a regenerative way, one shaft working in a calcination way during a predetermined time period during which at least another shaft works in a preheating way, and inversely,
the calcining way comprising:
said loading step of carbonated mineral stones at the top of a kiln shaft,
said calcining step by means of an increase of temperature inside said carbonated mineral stones having been preheated, with production of said decarbonated calcined material and release of a gaseous stream which flows in co-current with the calcined material, and
through said crossover channel, a passage of said gaseous stream toward the at least one shaft working in a preheating way,
said preheating way comprising:
said preheating step of the loaded carbonated mineral stones by heat exchange with said gaseous stream coming from the crossover channel, which is ascending and flows in counter-current through the loaded carbonated mineral stones, and
said exhausting step of said gaseous stream as gaseous effluent at the top of said at least one shaft in preheating way,
said cooling step comprising a supply of cooling air at the bottom of each of said shafts or only of the shaft working in the calcining way,
characterized in that said method further comprises
recirculating a fraction of the gaseous effluent exhausted from the top of said at least one shaft in preheating way,
outside the kiln, heating said recirculated fraction of gaseous effluent by means of at least one heating device able to heat gas, and
injecting the heated recirculated fraction of gaseous effluent into the shaft working in calcining way at a level which is located at the top of the calcination zone and both from the middle of this shaft and from its periphery, in order to obtain said increase of temperature allowing a calcining of the carbonated mineral stones in an evenly distributed manner.

2: Method according to claim 1, further comprising a step for extracting the heated cooling air from each shaft wherein cooling air has been supplied at a level located below the crossover channel, the gaseous effluent exiting from the kiln being CO₂ concentrated.

3: Method according to claim 2, further comprising at least one heat exchange between the heated cooling air, which has been extracted outside the kiln, and said recirculated fraction of gaseous effluent before said step of heating by means of said device able to heat a gas.

4: Method according to claim 2 or 3, comprising an introduction into the crossover channel of a gaseous mixture of a first part of said recirculated fraction of gaseous effluent which has been heated outside the kiln by means of said device able to heat a gas and of a second part of said fraction which has not been heated by said device, said mixture so having an adjusted temperature lower than said temperature allowing a calcining of the carbonated mineral stones but higher than the temperature of recarbonation of the calcined mineral stones.

5: Method according to claim 1, wherein a portion of the recirculated fraction of gaseous effluent which has not been heated is injected at the top of each shaft in calcining way.

6: Parallel flow regenerative kiln, comprising at least two shafts (1, 2) interconnected by a crossover channel (4),
each shaft comprising, in position in service or out of service,
at least one entrance opening (5) for loading carbonated mineral stones, at the top of the shaft,
at least one exit opening (12) for discharging a decarbonated calcined material, at the bottom of the shaft,
a removal duct (14) for exhausting a gaseous effluent from the top of the shaft, and
a cooling air supply (9) at the bottom of the shaft for cooling the decarbonated calcined material to be discharged,
the kiln further comprising a reversing system (16) which is arranged to drive said positions in service and out of service of each shaft alternately in calcination working and in preheating working, a shaft (1) being in calcination working during a predetermined time period while at least another shaft (2) is in preheating working and inversely according to the control of said reversing system (16),
the shaft (1) in calcining working comprising from the top to the bottom successively a preheating zone (A), a calcination zone (B) and a cooling zone (C), and said interconnecting crossover channel (4) being located at the bottom of the calcination zone (B),
characterized in that each shaft comprises means for injecting a heated gas (6, 7, 29) inside the shaft (1) in calcination working at the top of the calcination zone (B) and both from the middle of this shaft and from its periphery,
and in that the kiln further comprises an external recirculation circuit (18) which comprises
a separation body (17) for taking off a fraction of said gaseous effluent from said removal duct (14),
a heating device (20) able to heat gas which is connected with said separation body (17) and arranged for heating said fraction of gaseous effluent, and
said means for injecting a heated gas (6, 7, 29) inside the shaft (1) in calcination working, which are connected to the heating device (20) and inject said heated fraction of gaseous effluent at a temperature equal or higher than the temperature of calcination of the loaded mineral stones.

7: Parallel flow regenerative kiln according to claim 6, further comprising means for removing (22, 24, 31) from the kiln the cooling air which has been heated in contact with the calcined material, at a level lower than the crossover channel (4).

8: Parallel flow regenerative kiln according to claim 6, characterized in that said means for injecting a heated gas comprise a cylindrical tube (7) which is suspended in the middle of each shaft and which is provided with perforations at the top of the calcining zone as well as, in each shaft, additional holes (6) in their shell at the same level.

9: Parallel flow regenerative kiln according to claim 7, characterized in that, at the bottom of each shaft, at a level lower than the crossover channel (4), said means for removing heated cooling air from the kiln comprise a central collector element (22) which communicates with an external extracting device (23).

10: Parallel flow regenerative kiln according to claim 7, characterized in that each shaft has a circular section and is provided with a peripheral channel (3) at the bottom of the calcination zone (B), said crossover channel (4) interconnecting the peripheral channels (3) of the shafts in order to allow a passage of gas from one shaft to another one, and in that, at a level lower than the peripheral channels and the crossover channel, said means for removing heated cooling air from the kiln comprise an annular collector (24) which communicates with an external extracting device (23).

11: Parallel flow regenerative kiln according to claim 7, characterized in that each shaft has a rectangular section, a side of one shaft facing a side of another shaft, the crossover channel interconnecting directly the shafts between said facing sides, and in that, at a level below the crossover channel, said means for removing heated cooling air from the kiln comprise on at least some sides of each shaft at least one collector which communicates with an external extracting device.

12: Parallel flow regenerative kiln according to claim 6, characterized in that said means for injecting a heated gas comprise an inner cylinder (28) which extend axially from the top to the bottom of each shaft and which is divided in at least two separated parts, an upper part (29) which is connected with the heating device (20) and is provided with perforations (30) at the top of the calcining zone and a lower part (31) which is connected with an external extracting device (23) and is provided with holes at the top of the cooling zone.

13: Parallel flow regenerative kiln according to claim 6, characterized in that the heating device (20) is a furnace equipped with at least one torch of plasma, an induction heating device, radiant panels, a microwave oven, a solar heating device, an oxyfuel burner or an heater by indirect exchange.

14: Parallel flow regenerative kiln according to claim 6, comprising a mixing chamber (33) which is connected to the recirculation circuit (18) downward the heating device (20) in order to collect a first part of said recirculated fraction of gaseous effluent which has been heated and to a separating body (34) which is arranged on the recirculation circuit (17) upwards the heating device (20) and is able to transfer to the mixing chamber a second part of said recirculated fraction of gaseous effluent which has not been heated by said heating device in order to obtain a gaseous mixture having an adjusted temperature lower than a temperature allowing a calcining of the carbonated mineral stones but higher than the temperature of recarbonation of the calcined mineral stones, said mixing chamber (33) being connected (27) to the crossover channel (4) in order to inject therein said gaseous mixture or to means for injecting a heated gas (6), in order to inject therein said gaseous mixture when the shaft is in pre-heating way.

15: Parallel flow regenerative kiln according to claim 6, wherein each shaft comprises a top opening (21) for introducing a third part of said taken off fraction of gaseous effluent, which has not been heated.

16: Parallel flow regenerative kiln according to claim 6, characterized in that at least one heat exchanger (25) supplied with heated cooling air extracted from the kiln is arranged on said external recirculation circuit (18).
